(19) United States
(12) Patent Application Publication
(10) Pub. No.: US 2014/0324245 A1
(43) Pub. Date: Oct. 30, 2014

(54) APPLICATION PROCESSOR AND DYNAMIC THERMAL MANAGEMENT METHOD THEREOF

(71) Applicant: Samsung Electronics Co., Ltd., Suwon-si (KR)

(72) Inventors: HEUNG-KYU KWON, Seongnam-si (KR); JAE-CHOON KIM, Incheon (KR); KYUNG-IL SUN, Suwon-si (KR)

(73) Assignee: Samsung Electronics Co., Ltd., Suwon-si (KR)

(21) Appl. No.: 14/104,011

(22) Filed: Dec. 12, 2013

(30) Foreign Application Priority Data
Apr. 26, 2013 (KR) 10-2013-0046883

(51) Int. Cl. G05B 13/02

(52) U.S. Cl. CPC G05B 13/02
USPC 700/299

(57) ABSTRACT

Provided is a dynamic thermal management method performed by an application processor which stores a first dynamic voltage and frequency scaling (DVFS) table and a second DVFS table, the method including comparing a surface temperature of a mobile apparatus with a critical surface temperature, controlling performance of the application processor according to the first DVFS table when the surface temperature is less than the critical surface temperature, and controlling performance of the application processor according to the second DVFS table when the surface temperature is not less than the critical surface temperature.

### CROSS-REFERENCE TO RELATED APPLICATIONS

This application claims priority under 35 U.S.C. §119 to Korean Patent Application No. 10-2013-0046883 filed on Apr. 26, 2013, the disclosure of which is hereby incorporated by reference in its entirety.

### BACKGROUND OF THE INVENTION

1. Field of the Invention

Exemplary embodiments of the present general inventive concept relate to an application processor, and more particularly, to an application processor capable of maximizing the performance thereof while maintaining a surface temperature of a mobile apparatus at a predetermined temperature or less, and dynamic thermal management thereof.

2. Description of the Related Art

In general, when a surface temperature of a mobile apparatus exceeds 40 degrees, a user of the mobile apparatus is likely to suffer low-temperature burns. Thus, the performance of an application processor should be improved while maintaining the surface temperature of the mobile apparatus to be less than 40 degrees. An operating frequency and voltage of the application processor should be lowered to decrease the surface temperature of the mobile apparatus.

Also, when an application processor installed in a mobile apparatus reaches a predetermined temperature, the operating speed of the application processor decreases to reduce the temperature thereof. This is called a throttling phenomenon (or a performance degradation phenomenon). Increasing the performance of the application processor may be, however, limited due to the throttling phenomenon.

### SUMMARY OF THE INVENTION

Exemplary embodiments of the present general inventive concept provide an application processor capable of maximizing the performance thereof while maintaining a surface temperature of a mobile apparatus to be less than a temperature at which low-temperature burns are likely to occur.

Exemplary embodiments of the present general inventive concept also provide a dynamic thermal management method performed by the application processor.

Additional features and utilities of the present general inventive concept will be set forth in part in the description which follows and, in part, will be obvious from the description, or may be learned by practice of the general inventive concept.

Exemplary embodiments of the present general inventive concept provide an application processor includes a memory device having a first dynamic voltage and frequency scaling (DVFS) table and a second DVFS table, and a central processing unit to compare a surface temperature of the application processor with a critical surface temperature, and control the performance of the application processor according to the first DVFS table when the surface temperature is less than the critical surface temperature, and control the performance of the application processor according to the second DVFS table when the surface temperature is not less than the critical surface temperature.

In one embodiment, the central processing unit may control the performance of the application processor according to a user scenario.

In one embodiment, the user scenario may include driving at least one of an application, a widget, or an event.

In one embodiment, the central processing unit may perform dynamical temperature control such that the application or the widget is driven at a maximum performance level, or the event is performed at a maximum performance level.

In one embodiment, the application processor may further include a graphic processing unit to control an image, and an image signal processor to process the image.

In one embodiment, the image signal processor controls a frame rate according to the first or second DVFS table.

In one embodiment, the central processing unit, the graphic processing unit, and the image signal processor may include thermal management units to measure temperatures thereof, respectively.

In one embodiment, each of the first and second DVFS tables may include information regarding an operating frequency or voltage of each of the central processing unit and the graphic processing unit.

In one embodiment, each of the first and second DVFS tables may include information regarding a frame rate of the image signal processor.

In one embodiment, the critical surface temperature may include temperatures at which low-temperature burns are likely to occur.

Exemplary embodiments of the present general inventive concept may also provide a dynamic thermal management method performed by an application processor which stores a first dynamic voltage and frequency scaling (DVFS) table and a second DVFS table includes comparing a surface temperature of the application processor with a critical surface temperature, controlling performance of the application processor according to the first DVFS table when the surface temperature is less than the critical surface temperature, and controlling performance of the application processor according to the second DVFS table when the surface temperature is not less than the critical surface temperature.

In one embodiment, the controlling of the performance of the application processor according to the first DVFS table may include comparing the temperature of the application processor with a first reference operating temperature, reducing the performance of the application processor according to the first DVFS table when the temperature of the application processor is equal to the first reference operating temperature, and increasing the performance of the application processor according to the first DVFS table when the temperature of the application processor is not equal to the first reference operating temperature.

In one embodiment, the controlling of the performance of the application processor according to the second DVFS table may include comparing the temperature of the application processor with a second reference operating temperature, reducing the performance of the application processor according to the second DVFS table when the temperature of the application processor is equal to the second reference operating temperature, and increasing the performance of the application processor according to the second DVFS table when the temperature of the application processor is not equal to the second reference operating temperature.

In one embodiment, the controlling of the performance of the application processor may include controlling a power supply voltage to be applied to the application processor, or a frequency of a clock signal to be supplied to the application processor.

Exemplary embodiments of the present general inventive concept may also provide a mobile apparatus includes an application processor, and a power management integrated circuit (PMIC) to supply power to the application processor. The application processor includes a memory device including a first dynamic voltage and frequency scaling (DVFS) table and a second DVFS table, and a central processing unit to compare a surface temperature of the mobile apparatus with a critical surface temperature, and control the performance of the application processor according to the first DVFS table when the surface temperature is less than the critical surface temperature, and control the performance of the application processor according to the second DVFS table when the surface temperature is not less than the critical surface temperature.

In one embodiment, the central processing unit may control the performance of the application processor according to a user scenario. The user scenario may include driving an application or a widget, or an event.

In one embodiment, the central processing unit may perform dynamical temperature control such that the application or the widget is driven at a maximum performance level, or the event is performed at a maximum performance level.

In one embodiment, the application processor may further include a graphic processing unit to control an image, and an image signal processor to process the image. The image signal processor controls a frame rate according to the first or second DVFS table.

In one embodiment, each of the first and second DVFS tables may include information regarding an operating frequency or voltage of each of the central processing unit and the graphic processing unit, or information regarding the frame rate of the image signal processor.

In one embodiment, the central processing unit may control the PMIC to control the operating voltage.

Exemplary embodiments of the present general inventive concept may also provide a method of dynamic thermal management of an application processor which stores a first dynamic voltage and frequency scaling (DVFS) table and a second DVFS table, the method including comparing a surface temperature of a mobile apparatus with a critical surface temperature, controlling at least one of a voltage and a clock rate of the application processor according to the first DVFS table when the surface temperature is less than the critical surface temperature, and controlling at least one of the voltage and the clock rate of the application processor according to the second DVFS table when the surface temperature is not less than the critical surface temperature.

The method may further include comparing the temperature of the application processor with a first reference operating temperature, reducing at least one of the voltage and the clock rate of the application processor according to the first DVFS table when the temperature of the application processor is equal to the first reference operating temperature, and increasing at least one of the voltage and the clock rate of the application processor according to the first DVFS table when the temperature of the application processor is not equal to the first reference operating temperature.

The method may further include comparing the temperature of the application processor with a second reference operating temperature, reducing at least one of the voltage and the clock rate of the application processor according to the second DVFS table when the temperature of the application processor is equal to the second reference operating temperature, and increasing at least one of the voltage and the clock rate of the application processor according to the second DVFS table when the temperature of the application processor is not equal to the second reference operating temperature.

Exemplary embodiments of the present general inventive concept may also provide a method of dynamic thermal management of an application processor which stores a first dynamic voltage and frequency scaling (DVFS) table and a second DVFS table, the method including comparing a surface temperature of a mobile apparatus with a critical surface temperature, controlling the application processor according to the first DVFS table when the surface temperature is less than the critical surface temperature, and controlling the application processor according to the second DVFS table when the surface temperature is not less than the critical surface temperature.

The controlling the application processor according to the first DVFS table may further include comparing the temperature of the application processor with a first reference operating temperature, reducing the performance the application processor according to the first DVFS table when the temperature of the application processor is equal to the first reference operating temperature, and increasing the performance of the application processor according to the first DVFS table when the temperature of the application processor is not equal to the first reference operating temperature.

The controlling the application processor according to the second DVFS table may further including comparing the temperature of the application processor with a second reference operating temperature, reducing at least one of the voltage and the clock rate of the application processor according to the second DVFS table when the temperature of the application processor is equal to the second reference operating temperature, and increasing at least one of the voltage and the clock rate of the application processor according to the second DVFS table when the temperature of the application processor is not equal to the second reference operating temperature.

### BRIEF DESCRIPTION OF THE DRAWINGS

The foregoing and other features and utilities of the present general inventive concept will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

These and/or other features and utilities of the present general inventive concept will become apparent and more readily appreciated from the following description of the embodiments, taken in conjunction with the accompanying drawings of which:

FIG. 1A is a block diagram illustrating a mobile apparatus in accordance with exemplary embodiments of the present general inventive concept;

FIG. 1B illustrates the mobile apparatus of FIG. 1A including a communications interface to communicate with devices coupled to a communications network;

FIG. 2A is a detailed block diagram of an application processor of FIGS. 1A-1B;

FIG. 2B is a block diagram illustrating a dynamic voltage & frequency scaling (DVFS) table of FIGS. 1A-1B;

FIG. 3 is a graph illustrating a comparison between a surface temperature of a mobile apparatus and an operating temperature of an application processor;

FIG. 4A is a graph illustrating a variation in the temperature of a general application processor according to time;

FIG. 4B is a graph illustrating a variation in the performance of a general central processing unit (CPU) according to time;

FIG. 4C is a graph illustrating a variation in the performance of a general graphic processing unit (GPU) according to time;

FIG. 5A is a graph illustrating a variation in the temperature of the application processor of FIG. 2 according to time;

FIG. 5B is a graph illustrating a variation in the temperature of a CPU of FIG. 2B according to time;

FIG. 5C is a graph illustrating a variation in the performance of a GPU of FIG. 2B according to time;

FIG. 6 is a flowchart illustrating a method of controlling the temperature of the application processor of FIGS. 1A-1B;

FIG. 7 is a flowchart illustrating a method of controlling the temperature of an application processor according to a first user scenario;

FIG. 8 is a flowchart illustrating dynamic thermal management performed by an application processor according to a second user scenario;

FIG. 9 is a flowchart illustrating dynamic thermal management performed by an application processor according to a third user scenario;

FIG. 10 is a block diagram illustrating a computer system including the application processor of FIG. 2 in accordance with exemplary embodiments of the present general inventive concept;

FIG. 11 is a block diagram illustrating a computer system including the application processor of FIG. 2 in accordance with exemplary embodiments of the present general inventive concept; and

FIG. 12 is a block diagram illustrating a computer system including the application processor of FIG. 2 in accordance with exemplary embodiments of the inventive concept.

### DETAILED DESCRIPTION OF THE PREFERRED EMBODIMENTS

Particular structural and functional descriptions regarding embodiments of the inventive concept set forth herein are simply provided to explain these embodiments. Thus, the inventive concept may be accomplished in other various embodiments and should not be construed as limited to the embodiments set forth herein.

The inventive concept may be embodied in different forms, and particular embodiments of the inventive concept will thus be illustrated in the drawings and described in the present disclosure in detail. However, the inventive concept is not limited to the particular embodiments and should be construed as covering all of modifications, equivalents, and substitutes thereof.

It will be understood that, although the terms ‘first’, ‘second’, ‘third’, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present inventive concept. Similarly, a second element, component, region, layer, or section discussed below could be termed a first element, component, region, layer, or section

It will be understood that when an element or layer is referred to as being “connected to,” or “coupled to” another element or layer, it can be directly connected or coupled to the other element or layer, or intervening elements or layers may be present. In contrast, when an element is referred to as being “directly connected to,” or “directly coupled to” another element or layer, there are no intervening elements or layers present. Similarly, other expressions describing the relations among constitutional elements, e.g., “between,’ and “directly between,”, or “adjacent to,” and “directly adjacent to,” should be construed.

The terminology used herein is for the purpose of describing particular embodiments only and is not intended to be limiting of the inventive concept. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When an embodiment of the inventive concept may be accomplished in a different way, a function or an operation specified in a particular block may be performed in an order that is different from that illustrated in a flowchart. For example, functions or operations specified in continuous two blocks may be actually substantially simultaneously performed, or may be performed in a reverse order, according to a related function or operation.

Hereinafter, exemplary embodiments of the inventive concept will be described with reference to the accompanying drawings.

An application processor in accordance with exemplary embodiments of the present general inventive concept operates at an increased performance level (e.g., a maximum performance level) while maintaining a surface temperature of a mobile apparatus that does not exceed a critical surface temperature. That is, exemplary embodiments of the present general inventive concept provide an application processor of a mobile apparatus to operate with an increased performance such that a surface temperature of the mobile apparatus does not exceed a predetermined surface temperature.

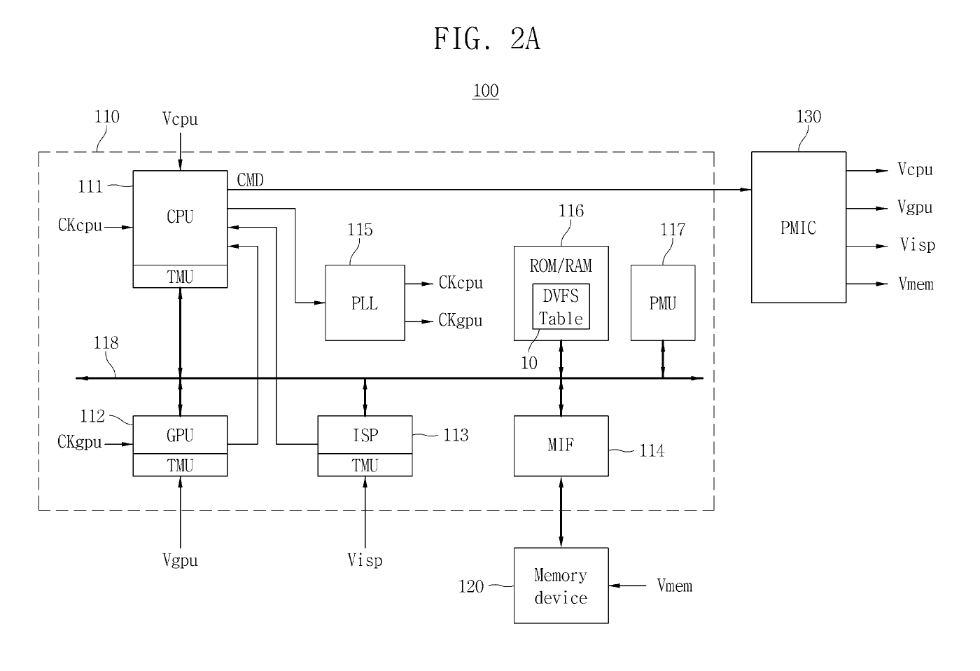

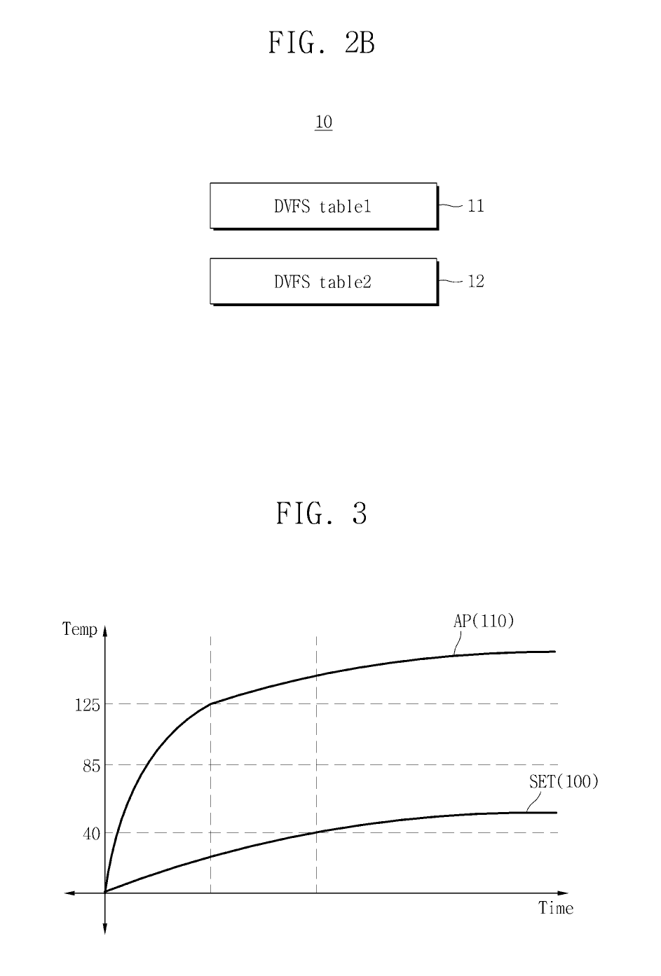

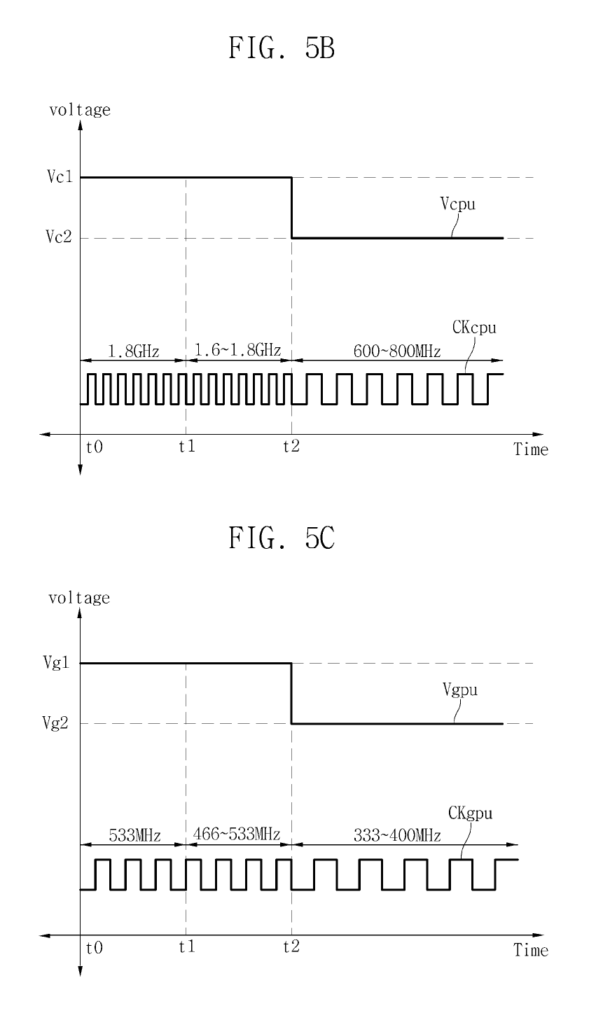

Specifically, an application processor in accordance with exemplary embodiments of the present general inventive concept is capable of being maintained at a maximum performance level while maintaining the surface temperature of the mobile apparatus so as not to exceed the critical surface temperature. The application processor in accordance with exemplary embodiments of the present general inventive concept will be described with reference to FIGS. 2 and 5A to 5C below.

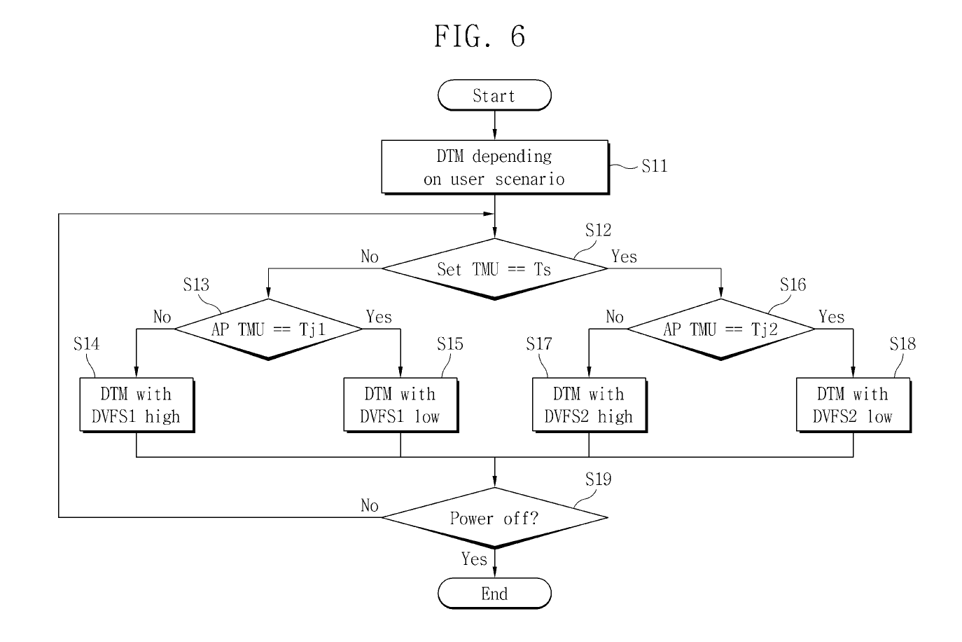

In accordance with exemplary embodiments of the present general inventive concept, dynamic thermal management is performed by an application processor according to, among other things, a user scenario to maintain an increased performance level (e.g., a maximum performance level) of the application processor while maintaining a surface temperature of a mobile apparatus not to exceed a critical surface temperature. The dynamic thermal management method performed by an application processor in according to exemplary embodiments of the present general inventive concept will be described with reference to FIGS. 6 to 9 below.

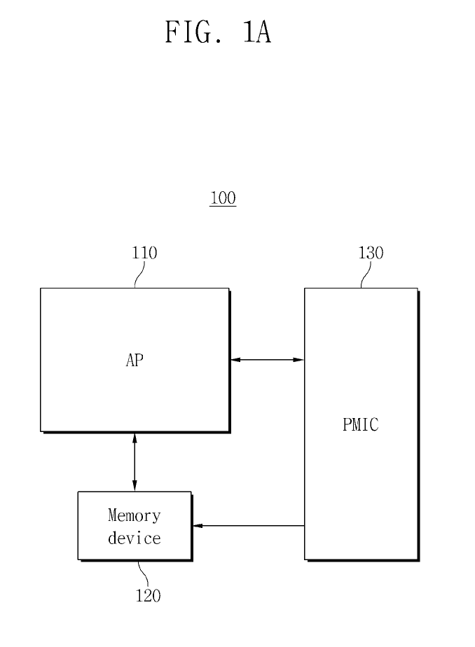

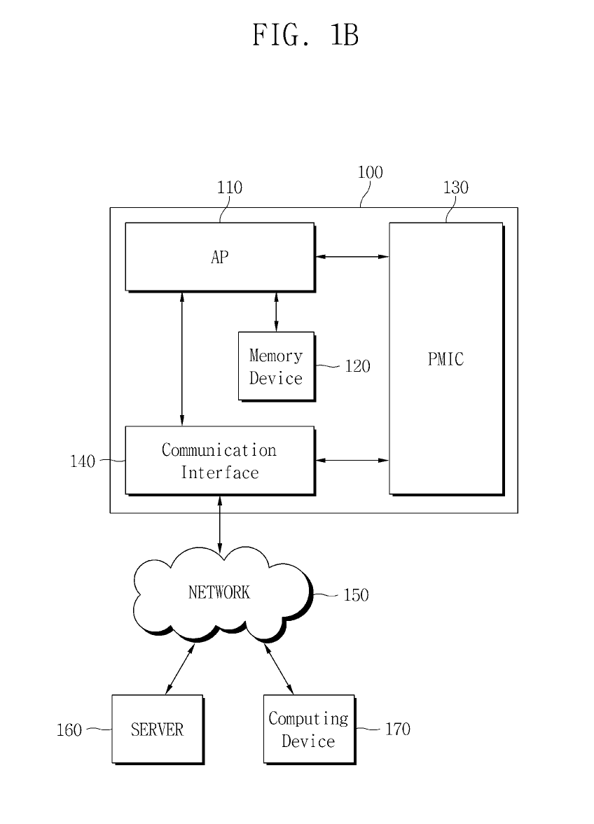

FIG. 1A illustrates a block diagram of a mobile apparatus 100 in accordance with exemplary embodiments of the present general inventive concept.

Referring to FIG. 1A, the mobile apparatus 100 may include an application processor 110, a memory device 120, and a power management integrated circuit (PMIC) 130 configured to supply power to the application processor 110 and the memory device 120.

The application processor 110 may access the memory device 120. The application processor 110 may include a memory controller (not illustrated) configured to control the memory device 120. The application processor 110 will be described in detail with reference to FIG. 2 below. The application processor 110 may be a central processing unit, an integrated circuit, a field programmable gate array, a programmable logic unit, and/or any other suitable processor to carry out the exemplary embodiments of the present general inventive concept. In exemplary embodiments of the present general inventive concept disclosed herein, the application processor 110 may be applied to smart phones, tablet personal computers (PCs), digital cameras, smart televisions (TVs), etc.

The memory device 120 may store an operating system (OS) for operating the mobile apparatus 100, and a plurality of applications to be driven on the OS. Also, the memory device 120 may store or output data according to a request from the application processor 110. In accordance with an embodiment of the inventive concept, the memory device 120 may be embodied as a dynamic random access memory (DRAM) or a flash memory device which is a non-volatile memory device.

The PMIC 130 is an integrated circuit which converts, manages, and distributes input power to stably supply power according to a request from an electronic device. Also, the PMIC 130 may not only function as an AC-to-DC converter and a DC-to-DC converter, but may also charge batteries, select an input voltage, adjust a voltage level, etc.

The PMIC 130 may supply power to all components of the mobile apparatus 100. In detail, the PMIC 130 may supply power to the application processor 110 and the memory device 120. For example, when the workload on the application processor 110 increases, the PMIC 130 may increase a voltage to be applied to the application processor 110. Similarly, when the workload on the application processor 110 decreases, the PMIC 130 may reduce a voltage to be applied to the application processor 110.

The mobile apparatus 100 may be embodied as a smart phone, a tablet PC, or a digital camera that operates according to the Android™ platform.

FIG. 1B illustrates the mobile apparatus 100 of FIG. 1A and described above that includes a communications interface 140 to communicate via a communications network 150 to one or more devices coupled to the communications network, such as a server 160 and/or a computing device 170. The communications interface 140 may be a wired and/or wireless communications interface. In exemplary embodiments of the present general inventive concept, the communications network 150 may be a 4G network environment.

FIG. 2A illustrates a detailed block diagram of the application processor 110 of FIGS. 1A-1B.

Referring to FIGS. 1A, 1B, and 2A, the application processor 110 may include a central processing unit (CPU) 111, a graphic processing unit (GPU) 112, an image signal processor 113, a memory interface (MIF) 114, a phase-locked loop (PLL) 115, a read only memory/random access memory (ROM/RAM) 116, a power management unit (PMU) 117, and a system bus 118 that connect these elements to one another.

The CPU 111 may control the performance of the application processor 110, according to either a surface temperature of the mobile apparatus 100 or an operating temperature of the application processor 110.

The GPU 112 may perform graphic processing to display an image on a screen of mobile apparatus 100. The image signal processor 113 may convert an image signal received from a camera (not illustrated) of the mobile apparatus 100 into an image. The GPU 112 and the image signal processor 113 may each be a processor, a field programmable gate array, a programmable logic unit, an integrated circuit, and/or any suitable processor to carry out the exemplary embodiments of the present general inventive concept disclosed herein.

The CPU 111, the GPU 112, and the image signal processor 113 may each access the memory device 120 via the MIF 114. The CPU 111, the GPU 112, and the image signal processor 113 may each include a thermal measurement unit (TMU). Specifically, the TMU included in the CPU 111 may measure the temperature of the CPU 111, the TMU included in the GPU 112 may measure the temperature of the GPU 112, and the TMU included in the image signal processor 113 may measure the temperature of the image signal processor 113. An operating temperature of the application processor 110 may be estimated using the TMUs included in the respective CPU 111, GPU 112, and image signal processor 113. In one embodiment, the TMUs may be embodied as thermistors or temperature sensors. In exemplary embodiments of the present general inventive concept, the surface temperature of the mobile apparatus 100 may be monitored by a thermal measurement unit, such as a thermistor or a temperature sensor.

The CPU 111 may control the performances of the respective CPU 111, GPU 112, and image signal processor 113, according to a DVFS table 10. For example, the CPU 111 may increase the performance of the GPU 112 when the workload on the GPU 112 increases, and may decrease the performance of the GPU 112 when the workload on the GPU 112 decreases, according to the DVFS table 10. For example, the CPU 111 may increase the performance of the GPU 112 by controlling the PLL 115 to increase the GPU clock signal rate CKgpu and/or by controlling the PMIC 130 to increase the GPU voltage Vgpu.

The PLL 115 may generate a CPU clock signal CKcpu and a GPU clock signal CKgpu. The PLL 115 may transmit the CPU clock signal CKcpu to the CPU 111, and the GPU clock signal CKgpu to the GPU 112. The PLL 115 may adjust the frequencies of the CPU clock signal CKcpu and the GPU clock signal CKgpu, under control of the CPU 111.

For example, in order to reduce the operating temperature of the application processor 110, the CPU 111 may control the PLL 115 to lower the frequency of the GPU clock signal CKgpu to be supplied to the GPU 112. The CPU 111 may transmit a command CMD to the PMIC 130 to lower a power supply voltage to be applied to the GPU 112.

The ROM/RAM 116 may store temporary data to be used in the CPU 111 or the GPU 112, or may store boot codes, etc. The ROM/RAM 116 may store the DVFS table 10. The ROM/RAM 116 may be any suitable memory device to store data in accordance with the exemplary embodiments of the present general inventive concept disclosed herein.

In accordance with exemplary embodiments of the present general inventive concept, the DVFS table 10 may include a first DVFS table 11 according to a first reference operating temperature Tj1, and a second DVFS table 12 according to a second reference operating temperature Tj2. The DVFS table 10 will be described with reference to FIG. 2B below.

The CPU 111 may adjust the operating frequencies or voltages of the respective CPU 111, GPU 112, and image signal processor 113, according to either the surface temperature of the mobile apparatus 100 or the first and second reference operating temperatures Tj1 and Tj2 of the application processor 110, and the DVFS table 10.

The PMU 117 may cause a voltage applied from the PMIC 130 to be ‘on’/‘off’. The PMU 117 may include a plurality of finite-state machines. The PMU 117 may supply power to or may block the supply of power to the CPU 111, the GPU 112, the image signal processor 113, etc., under control of the plurality of finite-state machines. The PMU 117 may store the DVFS table 10, instead of the ROM/RAM 116.

The PMIC 130 may generate a CPU voltage Vcpu to be applied to the CPU 111, a GPU voltage Vgpu to be applied to the GPU 112, an ISP voltage Visp to be applied to the image signal processor 113, and a memory voltage Vmem to be applied to the memory device 120. The PMIC 130 may adjust the CPU voltage Vcpu, the GPU voltage Vgpu, the ISP voltage Visp, and the memory voltage Vmem according to a command CMD from the CPU 111. A method of controlling the temperature of the application processor 110 in accordance with exemplary embodiments of the present general inventive concept will be described in detail with reference to FIGS. 5A to 6 below.

FIG. 2B illustrates a block diagram of the DVFS table 10 of FIGS. 1A-1B.

Referring to FIGS. 2A and 2B, the DVFS table 10 includes the first DVFS table 11 and the second DVFS table 12.

The CPU 111 may refer to the first DVFS table 11 when the surface temperature of the mobile apparatus 100 is less than a critical temperature (e.g., a temperature at which low-temperature burns are likely to occur), or may refer to the second DVFS table 12 when the surface temperature of the mobile apparatus 100 is not less than the critical temperature.

The CPU 111 may maintain the operating temperature of the application processor 110 at the first reference operating temperature Tj1, according to the first DVFS table 11, and maintain the operating temperature of the application processor 110 at the second reference operating temperature Tj2, according to the second DVFS table 12.

FIG. 3 is a graph illustrating a comparison between the surface temperature of the mobile apparatus 100 of FIGS. 1A-1B and the operating temperature of the application processor 110 of FIGS. 1A-1B.

In FIGS. 2A, 2B and 3, the X-axis denotes time and the Y-axis denotes temperature. In general, when the surface temperature of the mobile apparatus 100 exceeds 40 degrees (C.), a user of the mobile apparatus 100 may suffer and/or sustain low-temperature burns. Thus, the surface temperature of the mobile apparatus 100 should be maintained to be less than 40 degrees Celsius (C).

The application processor 110 may include the CPU 111, the GPU 112, and the image signal processor 113. When the application processor 110 drives an application, a widget, or an event (e.g., where the application, widget, and/or event are stored in the memory device 120), the load on the CPU 111, the GPU 112, or the image signal processor 113 may increase. In other words, the operating temperature of the application processor 110 may increase due to an operation (i.e., operational load) of the CPU 111, the GPU 112, or the image signal processor 113. An increase in the temperature of the application processor 110 may result in an increase in the surface temperature of the mobile apparatus 100.

In general, the operating temperature of the application processor 110 may increase faster than the surface temperature of the mobile apparatus 100.

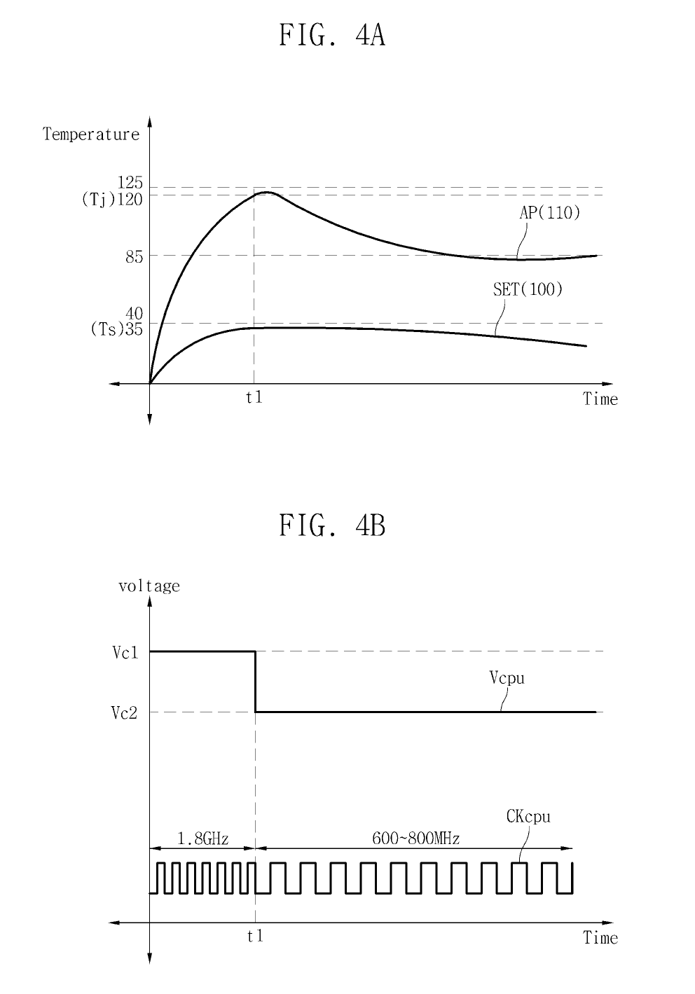

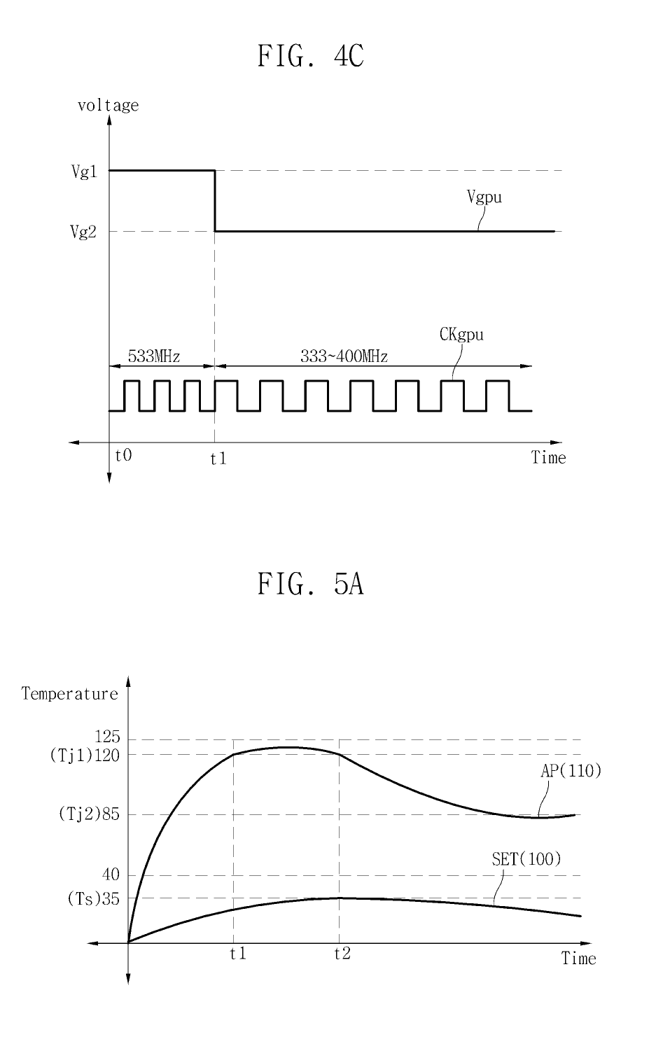

FIG. 4A is a graph illustrating a variation in the temperature of a general application processor according to time.

Referring to FIG. 4A, when the operating temperature of the general application processor (e.g., application processor 110 illustrated in FIGS. 1A-1B) exceeds a reference operating temperature Tj, e.g., 120 degrees (C.), at a point of time t1, the performance of the general application processor may be degraded regardless of the surface temperature (e.g., Tₛ illustrated in FIG. 4A) of a mobile apparatus (e.g., the mobile apparatus 100 illustrated in FIGS. 1A-1B). Thus, the surface temperature of the mobile apparatus will decrease.

A manufacturer of the general application processor may guarantee a maximum operating temperature of the general application processor. For example, the manufacturer of the general application processor may guarantee that the general application processor will normally operate at 120 degrees (C.).

The general application processor may include a CPU or a GPU. For example, as illustrated in FIGS. 1A, 1B, and 2A, the application processor 110 can include the CPU 111 and the GPU 112.

FIG. 4B is a graph illustrating a variation in the performance of a general CPU (e.g., the CPU 111 illustrated in FIG. 2A) according to time.

Referring to FIG. 4B, until a point of time t1, a clock signal CKcpu supplied to the CPU (e.g., the CPU 111 illustrated in FIG. 2A) may operate at 1.8 GHz, and a power supply voltage Vcpu applied to the CPU may be maintained at a voltage Vc1.

At the point of time t1, the operating temperature of an application processor (e.g. application processor 110 illustrated in FIGS. 1A-1B) may exceed a predetermined temperature, e.g., 120 degrees (C.). After the point of time t1, the clock signal CKcpu supplied to the CPU (e.g., the CPU 111 illustrated in FIG. 2A) may operate at 600 to 800 MHz to decrease the operating temperature of the application processor (e.g. application processor 110 illustrated in FIGS. 1A-1B). The power supply voltage Vcpu applied to the CPU may be maintained at a voltage Vc2 that is lower than the voltage Vc1.

FIG. 4C is a graph illustrating a variation in the performance of a general GPU according to time.

Referring to FIG. 4C, a clock signal CKgpu supplied to the GPU (e.g., the GPU 112) may operate at 533 MHz, and a power supply voltage Vgpu applied to the GPU may be maintained at a voltage Vg1, from a point of time t0 to a point of time t1.

After the point of time t1, the clock signal CKgpu supplied to the GPU may operate at 333 to 400 MHz, and the power supply voltage Vgpu applied to the GPU may be maintained at a voltage Vg2 that is lower than the voltage Vg1.

FIG. 5A is a graph illustrating a variation in the temperature of the application processor 110 of FIG. 2 according to time.

Referring to FIGS. 2A, 2B, and 5A, the application processor 110 may set a plurality of reference operating temperatures, e.g., reference operating temperatures Tj1 and Tj2. For example, the first and second reference operating temperatures Tj1 and Tj2 of the application processor 110 may be set to 120 degrees (C.) and 85 degrees (C.), respectively. A critical surface temperature Ts of the mobile apparatus 100 may be set to 35 degrees (C.).

At a point of time t1, even if the operating temperature of the application processor 110 exceeds 120 degrees (C.), the performance of the application processor 110 may be maintained according to the first DVFS table 11 unless the surface temperature of the mobile apparatus 100 exceeds 35 degrees (C.), i.e., the critical surface temperature Ts.

At a point of time t2, when the surface temperature of the mobile apparatus 100 exceeds 35 degrees (C.), the performance of the application processor 110 may be degraded and/or reduced according to the second DVFS table 12 to decrease the surface temperature of the mobile apparatus 100. Thus, the surface temperature of the mobile apparatus 100 may be lowered.

FIG. 5B is a graph illustrating a variation in the temperature of the CPU 111 of FIG. 2A according to time.

Referring to FIG. 5B, the performance of the application processor 110 may be improved before the operating temperature thereof exceeds a first reference operating temperature Tj1. At a point of time t1, when the operating temperature of the application processor 110 exceeds the first reference operating temperature Tj1, the performance of the application processor 110 may be controlled according to the first DVFS table 11 to lower the temperature of the application processor 110. That is, the performance of the application processor 110 may be controlled such that the operating temperature of the application processor 110 may be maintained at 120 degrees (C.).

For example, from a point of time t0 to the point of time t1, a clock signal CKcpu supplied to the CPU 111 may operate at 1.8 GHz, and a power supply voltage Vcpu applied to the CPU 111 may be maintained at a voltage Vc1.

From the point of time t1 to a point of time t2, the clock signal CKcpu supplied to the CPU 111 may operate at 1.6 to 1.8 GHz, and the power supply voltage Vcpu applied to the CPU 111 may be maintained at the voltage Vc1.

At the point of time t2, when the surface temperature of the mobile apparatus (SET) 100 exceeds 35 degrees (C.), the performance of the application processor 110 may be controlled according to the second DVFS table 12 to decrease the temperature of the application processor 110. That is, the performance of the application processor 110 may be controlled such that the temperature of the application processor 110 may be maintained at 85 degrees, which is a second reference operating temperature Tj2.

For example, after the point of time t2, the clock signal CKcpu supplied to the CPU 111 may operate at 600 to 800 MHz, and the power supply voltage Vcpu applied to the CPU 111 may be maintained at a voltage Vc2 which is lower than the voltage Vc1.

FIG. 5C is a graph illustrating a variation in the performance of the GPU 112 of FIG. 2A according to time.

As illustrated in FIG. 5C, from a point of time t0 to a point of time t1, the clock signal CKgpu supplied to the GPU 112 may operate at 533 MHz, and the power supply voltage Vcpu applied to the GPU 112 may be maintained at a voltage Vg1.

From the point of time t1 to a point of time t2, the clock signal CKgpu supplied to the GPU 112 may operate at 466 to 533 MHz, and the power supply voltage Vcpu applied to the GPU 112 may be maintained at the voltage Vg1.

After the point of time t2, the clock signal CKgpu supplied to the GPU 112 may operate at 333 to 400 MHz, and the power supply voltage Vcpu applied to the GPU 112 may be maintained at a voltage Vg2 which is lower than the voltage Vg1.

FIG. 6 is a flowchart illustrating a method of controlling the temperature of the application processor 110 of FIG. 1.

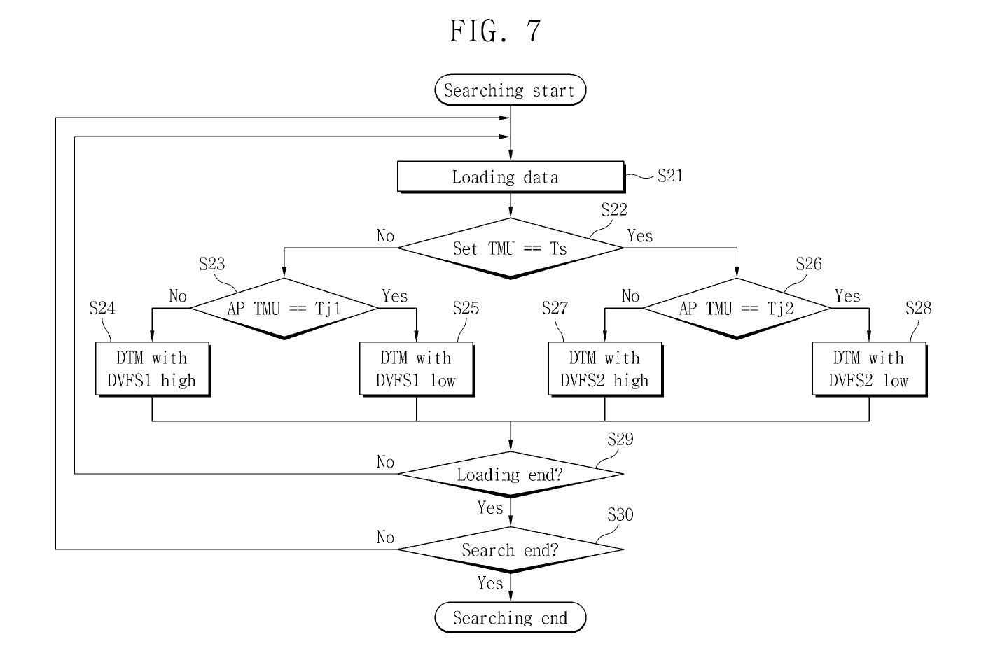

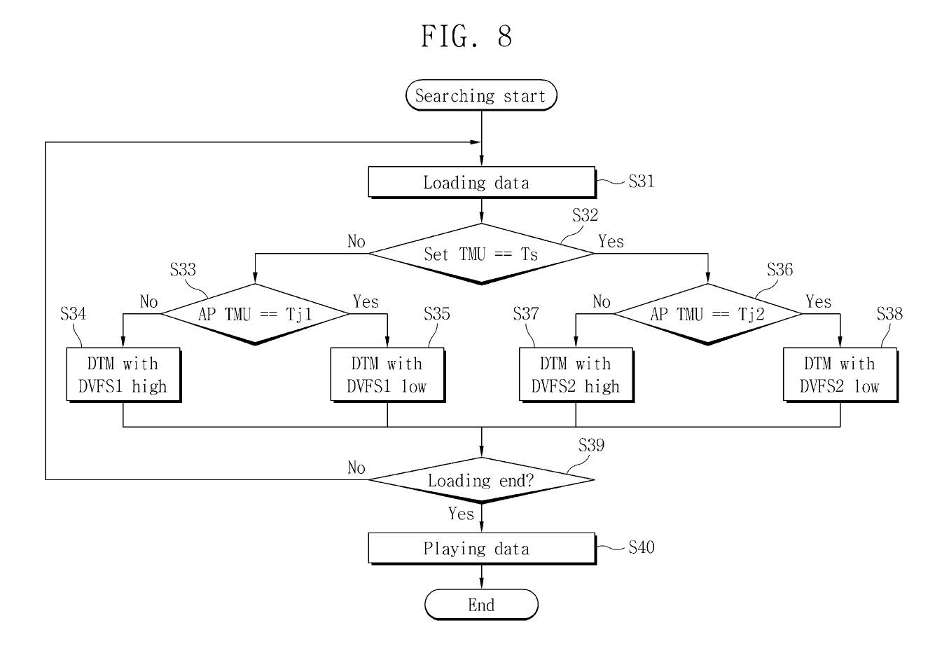

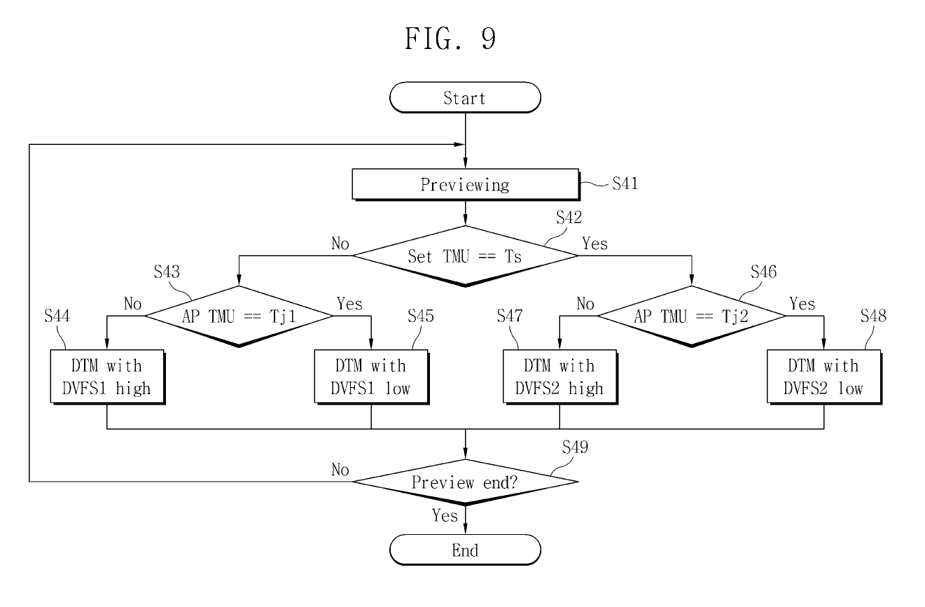

Referring to FIGS. 2, 5, and 6, in operation S11, the application processor 110 may perform dynamic thermal management (DTM) according to a user scenario, which will be described in detail with reference to FIGS. 7 to 9 below. For example, FIG. 7 illustrates controlling the temperature of the application processor 110 of FIGS. 1A-1B when the user scenario is Internet searching. FIG. 8 illustrates dynamic thermal management performed when the user scenario is when a moving picture data is downloaded and played by the mobile apparatus 100. FIG. 9 illustrates dynamic thermal management performed when the user scenario is a preview operation.

Referring to FIGS. 2, 5, and 6, in operation S12, the application processor 110 checks the surface temperature of the mobile apparatus 100. For example, the application processor 110 performs operation S16 when the surface temperature of the mobile apparatus 100 is 35 degrees (C.), which is a critical surface temperature Ts, and performs operation S13 when the surface temperature of the mobile apparatus 100 is not 35 degrees (C.). As described above, the surface temperature of the mobile device 100 can be determined by a thermal measurement unit (TMU), such as a thermistor or a temperature sensor.

In operation S13, the application processor 110 checks the operating temperature of the application processor 110, by, for example, monitoring the TMU of the application processor 110. The application processor 110 performs operation S15 when the operating temperature of the application processor 110 is equal to a first reference operating temperature Tj1, e.g., 120 degrees (C.), and performs operation S14 when the operating temperature of the application processor 110 is not equal to the first reference operating temperature Tj1.

In operation S14, the application processor 110 may improve the performance thereof according to the first DVFS table 11, and perform operation S19. That is, the performance of the application processor 110 may be increased according to the first DVFS table 11, and by increasing the voltage and/or clock cycles of the components of the application processor 110 illustrated in FIG. 2A and described above.

In operation S15, the application processor 110 may degrade the performance thereof according to the first DVFS table 11, and perform operation S19. That is, the performance of the application processor 110 may be decreased according to the first DVFS table 11, and by decreasing the voltage and/or clock cycles of the components of the application processor 110 illustrated in FIG. 2A and described above.

In operation S16, the application processor 110 checks the operating temperature of the application processor 110, by, for example, monitoring the TMU of the application processor 110. The application processor 110 may perform operation S18 when the operating temperature thereof is equal to a second reference operating temperature Tj2, e.g., 85 degrees, and performs operation S17 when the operating temperature thereof is not equal to the second reference operating temperature Tj2.

In operation S17, the application processor 110 may improve the performance thereof according to the second DVFS table 12, and perform operation S19. That is, the performance of the application processor 110 may be increased according to the second DVFS table 12, and by increasing the voltage and/or clock cycles of the components of the application processor 110 illustrated in FIG. 2A and described above.

In operation S18, the application processor 110 may degrade the performance thereof according to the second DVFS table 12, and perform operation S19. That is, the performance of the application processor 110 may be decreased according to the second DVFS table 12, and by decreasing the voltage and/or clock cycles of the components of the application processor 110 illustrated in FIG. 2A and described above.

In operation S19, the application processor 110 may discontinue dynamic thermal management when the mobile apparatus 100 is powered off, and performs operation S12 when the mobile apparatus 100 is not powered off.

FIG. 7 is a flowchart illustrating a method of controlling the temperature of the application processor 110 of FIG. 2A according to a first user scenario.

The first user scenario exemplifies Internet searching. According to the first user scenario, a user may perform Internet searching using the mobile apparatus 100. In this case, the load on the CPU 111 may increase. When downloading of the results of performing the Internet searching is ended, the load on the CPU 111 may decrease. That is, the mobile device 100 may communicate via the communications network 150 with one or more devices coupled to the network 150 when performing a search. The results of the search may be obtained, for example, server 160 that is communicatively coupled to the mobile apparatus 100 via the communications network 150.

Referring to FIGS. 2 and 7, in operation S21, when search data is input to the mobile apparatus 100, the application processor 110 may download searched data (e.g., from the server 160 and/or the computing device 170 communicatively coupled to the mobile apparatus 100 via the communications network 150).

In operation S22, the application processor 110 checks the surface temperature of the mobile apparatus 100. For example, the application processor 110 may perform operation S26 when the surface temperature of the mobile apparatus 100 is 35 degrees, which is a critical surface temperature Ts, and perform operation S23 when the surface temperature of the mobile apparatus 100 is not 35 degrees, which is the critical surface temperature Ts. As described above, the surface temperature of the mobile device 100 can be determined by a thermal measurement unit (TMU), such as a thermistor or a temperature sensor.

In operation S23, the application processor 110 checks the operating temperature of the application processor 110. The application processor 110 may perform operation S25 when the operating temperature of the application processor 110 is equal to a first reference operating temperature Tj1, e.g., 120 degrees, and perform operation S24 when the operating temperature of the application processor 110 is not equal to the first reference operating temperature Tj1.

In operation S24, the application processor 110 may improve the performance thereof according to the first DVFS table 11, and perform operation S29. That is, the performance of the application processor 110 may be increased according to the first DVFS table 11, and by increasing the voltage and/or clock cycles of the components of the application processor 110 illustrated in FIG. 2A and described above.

In operation S25, the application processor 110 may degrade the performance thereof according to the first DVFS table 11, and perform operation S29. That is, the performance of the application processor 110 may be decreased according to the first DVFS table 11, and by decreasing the voltage and/or clock cycles of the components of the application processor 110 illustrated in FIG. 2A and described above.

In operation S26, the application processor 110 checks the operating temperature thereof by, for example, monitoring the TMU of the application processor 110. The application processor 110 may perform operation S28 when the operating temperature of the application processor 110 is equal to a second reference operating temperature Tj2, e.g., 85 degrees, and may perform operation S27 when the operating temperature of the application processor 110 is not equal to the second reference operating temperature Tj2.

In operation S27, the application processor 110 may improve the performance thereof according to the second DVFS table 12, and perform operation S29. That is, the performance of the application processor 110 may be increased according to the second DVFS table 12, and by increasing the voltage and/or clock cycles of the components of the application processor 110 illustrated in FIG. 2A and described above.

In operation S28, the application processor 110 may degrade the performance thereof according to the second DVFS table 12, and perform operation S29. That is, the performance of the application processor 110 may be decreased according to the second DVFS table 12, and by decreasing the voltage and/or clock cycles of the components of the application processor 110 illustrated in FIG. 2A and described above.

In operation S29, operation S30 may be performed when downloading of searched data is ended, and operation S21 may be performed when the downloading of the searched data is not completed.

When the downloading of the searched data is ended or the Internet searching is ended, the load on the CPU 111 may decrease, the CPU 111 may decrease the frequency and power supply voltage therefor, according to the first or second DVFS table 11 or 12.

When the surface temperature of the mobile apparatus 100 reaches a critical surface temperature Ts, the performance of the CPU 111 may be controlled according to the second DVFS table 12.

In operation S30, the application processor 110 may discontinue dynamic thermal management when the Internet searching is ended, and perform operation S21 when the Internet searching is not ended.

FIG. 8 is a flowchart illustrating dynamic thermal management performed by the application processor 110 of FIG. 2A according to a second user scenario.

The second user scenario exemplifies a case in which a large amount of moving picture data is downloaded and played in, for example, a 4-generation (4G) network environment, and/or any suitable wireless communication network environment.

The mobile apparatus 100 supporting a 4G network and/or communicating with a communication network (e.g., communications network 150 as illustrated in FIG. 1B) is capable of transmitting/receiving an increased amount of data (e.g., a large amount data and/or predetermined amount of data) within a reduced amount of time (e.g., a short time). Thus, when a large amount of data, such as moving picture data, is downloaded (e.g., via the communications network 150), the load on the CPU 111 significantly increases. While the mobile apparatus 100 downloads the data, the load on the CPU 111 may increase. When the downloading of the data is ended, the load on the CPU 111 may decrease.

Referring to FIGS. 2 and 8, in operation S31, the application processor 110 may download a large amount of moving picture data in the 4G network environment and/or the communications network environment (e.g., the communications network 150).

In operation S32, the application processor 110 checks the surface temperature of the mobile apparatus 100 by, for example, monitoring the TMU of the application processor 110. For example, the application processor 110 may perform operation S36 when the surface temperature of the mobile apparatus 100 is 35 degrees, which is a critical surface temperature Ts, and perform operation S33 when the surface temperature of the mobile apparatus 100 is not 35 degrees, which is the critical surface temperature Ts.

In operation S33, the application processor 110 checks the operating temperature of the application processor 110. The application processor 110 may perform operation S35 when the operating temperature of the application processor 110 is equal to a first reference operating temperature Tj1, e.g., 120 degrees, and perform operation S34 when the operating temperature of the application processor 110 is not equal to the first reference operating temperature Tj1.

In operation S34, the application processor 110 may improve the performance thereof according to the first DVFS table 11, and perform operation S39. That is, the performance of the application processor 110 may be increased according to the first DVFS table 11, and by increasing the voltage and/or clock cycles of the components of the application processor 110 illustrated in FIG. 2A and described above.

In operation S35, the application processor 110 may degrade the performance thereof according to the first DVFS table 11, and perform operation S39. That is, the performance of the application processor 110 may be decreased according to the first DVFS table 12, and by decreasing the voltage and/or clock cycles of the components of the application processor 110 illustrated in FIG. 2A and described above.

In operation S36, the application processor 110 checks the operating temperature thereof. The application processor 110 may perform operation S38 when the operating temperature of the application processor 110 is equal to a second reference operating temperature Tj2, e.g., 85 degrees, and perform operation S37 when the operating temperature of the application processor 110 is not equal to the second reference operating temperature Tj2.

In operation S37, the application processor 110 may improve the performance thereof according to the second DVFS table 12, and perform operation S39. That is, the performance of the application processor 110 may be increased according to the second DVFS table 12, and by increasing the voltage and/or clock cycles of the components of the application processor 110 illustrated in FIG. 2A and described above.

In operation S38, the application processor 110 may degrade the performance thereof according to the second DVFS table 12, and perform operation S39. That is, the performance of the application processor 110 may be decreased according to the second DVFS table 12, and by decreasing the voltage and/or clock cycles of the components of the application processor 110 illustrated in FIG. 2A and described above.

In operation S39, operation S40 may be performed when the downloading of the moving picture data is ended, and operation S31 may be performed when the downloading of the moving picture data is not ended.

In operation S40, the downloaded moving picture data is played.

The CPU 111 may play the downloaded moving picture data. In general, when the application processor 110 consumes 7 watts (W) of power to download the moving picture data, the CPU 111 may consume 3 W of power to play the moving picture data. Thus, while the CPU 111 plays the downloaded moving picture data, the load on the CPU 111 may decrease, and the load on the GPU 112 may increase. When the surface temperature of the mobile apparatus 100 reaches a critical surface temperature Ts, the performance of the CPU 111 and/or the performance of the GPU 112 may be controlled according to the second DVFS table 12.

FIG. 9 is a flowchart illustrating dynamic thermal management performed by the application processor 110 of FIG. 2A according to a third user scenario.

The third user scenario exemplifies a preview operation performed by the mobile apparatus 100. In general, the preview operation is performed to check the content of a moving picture. Thus, the preview operation does not require an original image resolution but can be performed using fast content searching. Also, the preview operation does not require a long playback time (e.g., a playback time greater than a predetermined playback time).

If a moving picture is fast-searched for, the load on the GPU 112 may greatly increase. In this case, the GPU 112 may increase the frequency and power supply voltage therefor, according to the first DVFS table 11. The performance of the GPU 112 may be maintained until the operating temperature of the application processor 110 reaches a critical temperature. However, when a moving picture is played at normal speeds or the playing of the moving picture is stopped, the load on the GPU 112 may decrease.

The image signal processor 113 may control a frame rate thereof. Thus, even if the surface temperature of the mobile apparatus 100 reaches a critical surface temperature Ts, e.g., 40 degrees, the application processor 110 may continuously perform the preview operation by lowering the resolution of the moving picture.

Referring to FIGS. 2 and 9, in operation S41, the application processor 110 performs the preview operation. While the preview operation is performed, the loads on the GPU 112 and the image signal processor 113 may increase.

In operation S42, the application processor 110 checks the surface temperature of the mobile apparatus 100. For example, the application processor 110 may perform operation S46 when the surface temperature of the mobile apparatus 100 is 35 degrees, which is a critical surface temperature Ts, and perform operation S43 when the surface temperature of the mobile apparatus 100 is not 35 degrees, which is the critical surface temperature Ts.

In operation S43, the application processor 110 checks the operating temperature thereof. The application processor 110 may perform operation S45 when the operating temperature thereof is equal to a first reference operating temperature Tj1, e.g., 120 degrees, and perform operation S44 when the operating temperature thereof is not equal to the first reference operating temperature Tj1.

In operation S44, the application processor 110 may improve the performance thereof according to the first DVFS table 11, and perform operation S49. That is, the performance of the application processor 110 may be increased according to the first DVFS table 11, and by increasing the voltage and/or clock cycles of the components of the application processor 110 illustrated in FIG. 2A and described above.

In operation S45, the application processor 110 may degrade the performance thereof according to the first DVFS table 11, and perform operation S49. That is, the performance of the application processor 110 may be decreased according to the first DVFS table 11, and by decreasing the voltage and/or clock cycles of the components of the application processor 110 illustrated in FIG. 2A and described above.

In operation S46, the application processor 110 checks the operating temperature of the application processor 110. The application processor 110 may perform operation S48 when the operating temperature of the application processor 110 is equal to the second reference operating temperature Tj2, e.g., 85 degrees, and perform operation S47 when the operating temperature of the application processor 110 is not equal to the second reference operating temperature Tj2.

In operation S47, the application processor 110 may improve the performance thereof according to the second DVFS table 12, and perform operation S49. That is, the performance of the application processor 110 may be increased according to the second DVFS table 12, and by increasing the voltage and/or clock cycles of the components of the application processor 110 illustrated in FIG. 2A and described above.

In operation S48, the application processor 110 may degrade the performance thereof according to the second DVFS table 12, and perform operation S49. That is, the performance of the application processor 110 may be decreased according to the second DVFS table 12, and by decreasing the voltage and/or clock cycles of the components of the application processor 110 illustrated in FIG. 2A and described above.

In operation S49, dynamic thermal management is ended when the preview operation is ended, and operation S21 may be performed when the preview operation is not ended.

The manufacturer of the application processor 110 may provide the DVFS table 10 to the manufacturer of the mobile apparatus 100 (SET maker). Since the heat dissipation performance of the mobile apparatus 100 depends on the design, size, and materials of the mobile apparatus 100 and the arrangement of IC components of the mobile apparatus 100, the manufacturer of the mobile apparatus 100 may set final DVFS setting values in the mobile apparatus 100. Thus, the manufacturer of the mobile apparatus 100 may install the application processor 110 into the mobile apparatus 100, and set the DVFS table 10 and a temperature criterion to be applied to the application processor 110. Here, the temperature criterion may be a temperature that is actually set not to exceed a predetermined temperature for either the operating temperature of the application processor 110 or the surface temperature of the mobile apparatus 100.

When a mobile apparatus of another manufacturer in which the application processor 110 of the manufacturer according to the inventive concept is purchased and a certain application is then performed using reverse engineering software in order to prove an infringement of the inventive concept, dynamic thermal management or predetermined DVFS values of the other manufacturer may be revealed. Thus, whether the other manufacturer has infringed the inventive concept may be determined.

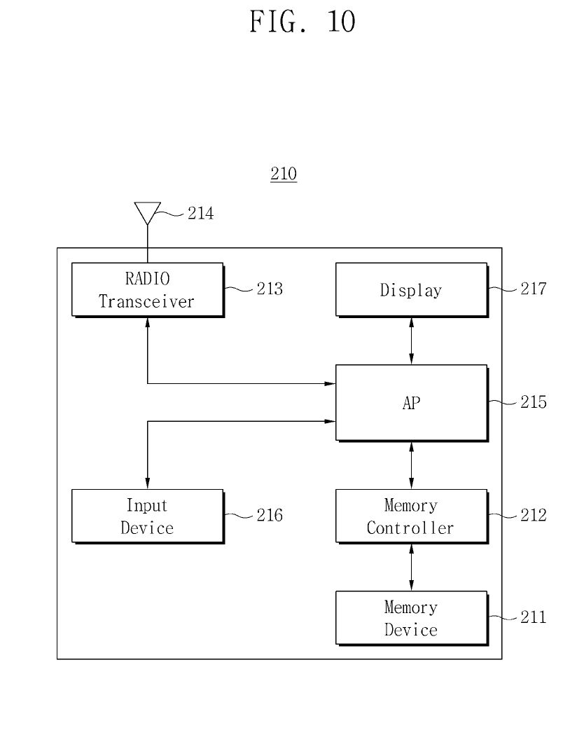

FIG. 10 is a block diagram of a computer system 210 including the application processor 110 of FIG. 2A in accordance with an embodiment of the present general inventive concept.

Referring to FIG. 10, the computer system 210 includes a memory device 211, a memory controller 212 to control the memory device 211, a radio transceiver 213, an antenna 214, an application processor 215, an input device 216, and a display device 217. The memory device 211 and the application processor 215 may be similar to the application processor 110 and memory device 120, respectively, as illustrated in FIGS. 1A-1B and described above.

The radio transceiver 213 may transmit or receive a radio signal via the antenna 214. For example, the radio transceiver 213 may transform a radio signal received via the antenna 214 into a signal to be processed by the application processor 215.

Thus, the application processor 215 may process a radio signal received from the radio transceiver 213, and transmit the processed signal to the display device 217. The display device 217 may be liquid crystal display (LCD), light emitting diode (LED) display, an organic light emitting diode (OLED) display, a touchpad display, and/or any other suitable display. The radio transceiver 213 may transform a signal received from the application processor 215 into a radio signal, and output the radio signal to the outside via the antenna 214.

The input device 216 is a device via which a control signal to control an operation of the application processor 215 or data that is to be processed by the application processor 215 is input, and may be a pointing device such as a touch pad or a computer mouse, a keypad, or a keyboard.

In one embodiment, the memory controller 212 to control an operation of the memory device 211 may be embodied as a part of the application processor 215, or may be a chip installed separately from the application processor 215.

In one embodiment, the application processor 215 may be the application processor 110 of FIG. 2A.

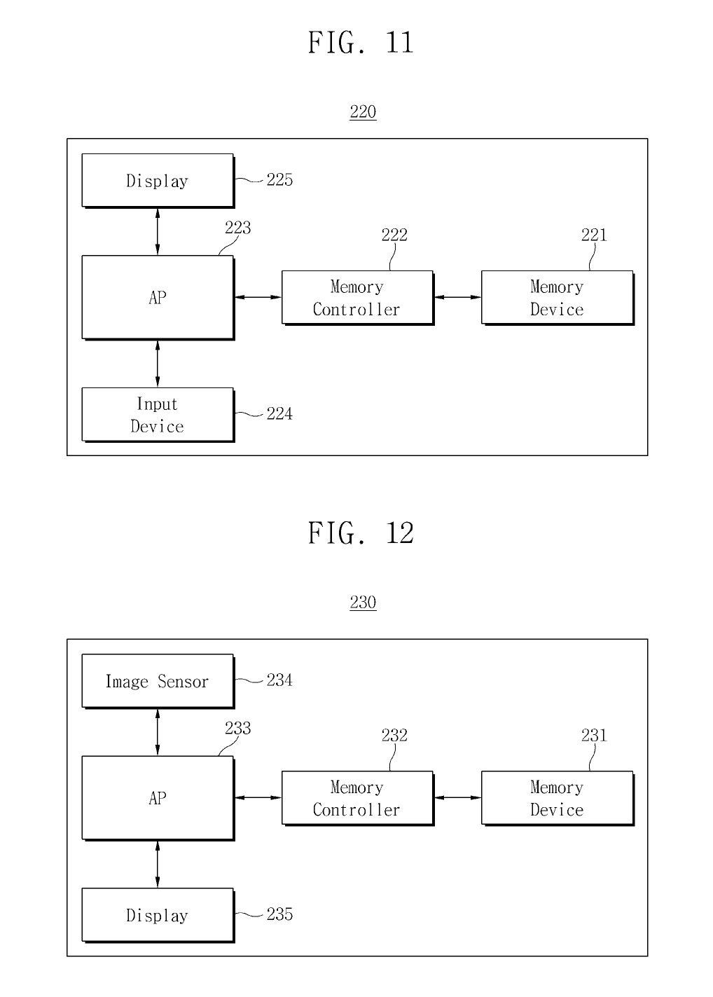

FIG. 11 is a block diagram of a computer system 220 including the application processor 110 of FIG. 2A in accordance with exemplary embodiments of the present general inventive concept.

Referring to FIG. 11, the computer system 220 may be a personal computer (PC), a network server, a tablet PC, a net-book, an e-reader, a personal digital assistant (PDA), a portable multimedia player (PMP), an MP3 player, or an MP4 player.

The computer system 220 includes a memory device 221, a memory controller 222 configured to control a data processing operation of the memory device 221, an application processor 223, an input device 224, and a display device 225. The memory device 221 and the application processor 223 may be similar to the application processor 110 and memory device 120, respectively, as illustrated in FIGS. 1A-1B and described above. The input device 224 and the display device 225 may be similar to the input device 216 and the display device 217, respectively, as illustrated in FIG. 10 and as described above.

The application processor 223 may display data stored in the memory device 221 on the display device 225, according to data received via the input device 224. For example, the input device 224 may be a pointing device such as a touch pad or a computer mouse, a keypad, or a keyboard. The application processor 223 may control overall operations of the computer system 220 and an operation of the memory controller 222.

In one embodiment, the memory controller 222 capable of controlling an operation of the memory device 221 may be embodied as a part of the application processor 223, or may be embodied as a chip installed separately from the application processor 223,

In one embodiment, the application processor 223 may be embodied as the application processor 110 of FIG. 2.

FIG. 12 is a block diagram of a computer system 230 including the application processor 110 of FIG. 2 in accordance with another embodiment of the inventive concept.

Referring to FIG. 12, the computer system 230 may be embodied as an image process device, e.g., a digital camera, or a cellular phone, a smart phone, or a tablet PC with a built-in digital camera.

The computer system 230 includes a memory device 231, and a memory controller 232 capable of controlling a data processing operation (e.g., a write/read operation) of the memory device 231. The computer system 230 may further include an application processor 233, an image sensor 234, and a display device 235. The application processor 233 and the display device 235 may be similar to the application processor 110 and memory device 120, respectively, as illustrated in FIGS. 1A-1B and described above.

The image sensor 234 of the computer system 230 transforms an optical image into digital signals, and transmits the digital signals to the application processor 233 or the memory controller 232. The digital signals may be displayed on the display device 235 or stored in the memory device 231 by the memory controller 232, under control of the application processor 233.

The data stored in the memory device 231 is displayed on the display device 235, under control of the application processor 233 or the memory controller 232.

In one embodiment, the memory controller 232 capable of controlling an operation of the memory device 231 may be embodied as a part of the application processor 233, or may be embodied as a chip installed separately from the application processor 233,

In one embodiment, the application processor 233 may be embodied as the application processor 110 of FIG. 2.

An application or a widget may be executed at a maximum performance level through dynamic thermal management performed by an application processor in accordance with an embodiment of the inventive concept, according to a user scenario.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An application processor comprising:
a memory device having a first dynamic voltage and frequency scaling (DVFS) table and a second DVFS table; and
a central processing unit to compare a surface temperature of a mobile apparatus with a critical surface temperature, and control the performance of the application processor according to the first DVFS table when the surface temperature is less than the critical surface temperature, and control the performance of the application processor according to the second DVFS table when the surface temperature is not less than the critical surface temperature.

2. The application processor of claim 1, wherein the central processing unit controls the performance of the application processor according to a user scenario.

3. The application processor of claim 2, wherein the user scenario comprises driving at least one of an application, a widget, or an event.

4. The application processor of claim 3, wherein the central processing unit performs dynamical temperature control such that the at least one of the application or widget is driven at a maximum performance level, or the event is performed at a maximum performance level.

5. The application processor of claim 1, further comprising:
a graphic processing unit to control an image; and
an image signal processor to process the image.

6. The application processor of claim 5, wherein the image signal processor controls a frame rate according to the first or second DVFS table.

7. The application processor of claim 5, wherein the central processing unit, the graphic processing unit, and the image signal processor comprise thermal management units to measure temperatures thereof, respectively.

8. The application processor of claim 5, wherein each of the first and second DVFS tables comprises information regarding an operating frequency or voltage of each of the central processing unit and the graphic processing unit.

9. The application processor of claim 5, wherein each of the first and second DVFS tables comprises information regarding a frame rate of the image signal processor.

10. The application processor of claim 1, wherein the critical surface temperature comprises temperatures at which low-temperature burns are likely to occur.

11. A dynamic thermal management method performed by an application processor which stores a first dynamic voltage and frequency scaling (DVFS) table and a second DVFS table, the method comprising:
comparing a surface temperature of a mobile apparatus with a critical surface temperature;
controlling performance of the application processor according to the first DVFS table when the surface temperature is less than the critical surface temperature; and
controlling performance of the application processor according to the second DVFS table when the surface temperature is not less than the critical surface temperature.

12. The method of claim 11, wherein the controlling of the performance of the application processor according to the first DVFS table comprises:
comparing the temperature of the application processor with a first reference operating temperature;
reducing the performance of the application processor according to the first DVFS table when the temperature of the application processor is equal to the first reference operating temperature; and
increasing the performance of the application processor according to the first DVFS table when the temperature of the application processor is not equal to the first reference operating temperature.

13. The method of claim 11, wherein the controlling of the performance of the application processor according to the second DVFS table comprises:
comparing the temperature of the application processor with a second reference operating temperature;
reducing the performance of the application processor according to the second DVFS table when the temperature of the application processor is equal to the second reference operating temperature; and
increasing the performance of the application processor according to the second DVFS table when the temperature of the application processor is not equal to the second reference operating temperature.

14. The method of claim 11, wherein the controlling of the performance of the application processor comprises:
controlling a power supply voltage to be applied to the application processor, or a frequency of a clock signal to be supplied to the application processor.

15. A mobile apparatus comprising:
an application processor; and
a power management integrated circuit (PMIC) to supply power to the application processor,
wherein the application processor comprises:
a memory device including a first dynamic voltage and frequency scaling (DVFS) table and a second DVFS table; and
a central processing unit to compare a surface temperature of the mobile apparatus with a critical surface temperature, and control the performance of the application processor according to the first DVFS table when the surface temperature is less than the critical surface temperature, and control the performance of the application processor according to the second DVFS table when the surface temperature is not less than the critical surface temperature.

16. The mobile apparatus of claim 15, wherein the central processing unit controls the performance of the application processor according to a user scenario,
wherein the user scenario comprises driving at least one of an application, a widget, or an event.

17. The mobile apparatus of claim 16, wherein the central processing unit performs dynamical temperature control such that the at least one of the application or widget is driven at a maximum performance level, or the event is performed at a maximum performance level.

18. The mobile apparatus of claim 15, wherein the application processor further comprises:
a graphic processing unit to control an image; and
an image signal processor to process the image,
wherein the image signal processor controls a frame rate according to the first or second DVFS table.

19. The mobile apparatus of claim 18, wherein each of the first and second DVFS tables comprises information regarding an operating frequency or voltage of each of the central processing unit and the graphic processing unit, or information regarding the frame rate of the image signal processor.

20. The mobile apparatus of claim 19, wherein the central processing unit controls the PMIC to control the operating voltage.

21. A method of dynamic thermal management of an application processor which stores a first dynamic voltage and frequency scaling (DVFS) table and a second DVFS table, the method comprising:
comparing a surface temperature of a mobile apparatus with a critical surface temperature;
controlling at least one of a voltage and a clock rate of the application processor according to the first DVFS table when the surface temperature is less than the critical surface temperature; and
controlling at least one of the voltage and the clock rate of the application processor according to the second DVFS table when the surface temperature is not less than the critical surface temperature.

22. The method of claim 21, wherein the controlling the application processor according to the first DVFS table comprises:
comparing the temperature of the application processor with a first reference operating temperature;
reducing at least one of the voltage and the clock rate of the application processor according to the first DVFS table when the temperature of the application processor is equal to the first reference operating temperature; and
increasing at least one of the voltage and the clock rate of the application processor according to the first DVFS table when the temperature of the application processor is not equal to the first reference operating temperature.

23. The method of claim 21, wherein the controlling of the application processor according to the second DVFS table comprises:
comparing the temperature of the application processor with a second reference operating temperature;
reducing at least one of the voltage and the clock rate of the application processor according to the second DVFS table when the temperature of the application processor is equal to the second reference operating temperature; and
increasing at least one of the voltage and the clock rate of the application processor according to the second DVFS table when the temperature of the application processor is not equal to the second reference operating temperature.

24. A method of dynamic thermal management of an application processor which stores a first dynamic voltage and frequency scaling (DVFS) table and a second DVFS table, the method comprising:
comparing a surface temperature of a mobile apparatus with a critical surface temperature;
controlling the application processor according to the first DVFS table when the surface temperature is less than the critical surface temperature; and
controlling the application processor according to the second DVFS table when the surface temperature is not less than the critical surface temperature.

25. The method of claim 24, wherein the controlling the application processor according to the first DVFS table comprises:
comparing the temperature of the application processor with a first reference operating temperature;
reducing the performance the application processor according to the first DVFS table when the temperature of the application processor is equal to the first reference operating temperature; and
increasing the performance of the application processor according to the first DVFS table when the temperature of the application processor is not equal to the first reference operating temperature.

26. The method of claim 24, wherein the controlling the application processor according to the second DVFS table comprises:
comparing the temperature of the application processor with a second reference operating temperature;
reducing at least one of the voltage and the clock rate of the application processor according to the second DVFS table when the temperature of the application processor is equal to the second reference operating temperature; and
increasing at least one of the voltage and the clock rate of the application processor according to the second DVFS table when the temperature of the application processor is not equal to the second reference operating temperature.
